(19) United States
(12) Patent Application Publication
(10) Pub. No.: US 2004/0048663 A1
(43) Pub. Date: Mar. 11, 2004

(54) Photographic pointer positioning device

(75) Inventors: Chiu-Hao Cheng, Yuan-Li Town (TW); Tsung-Chih Huang, Chungho City (TW); Ming-Gwo Cheng, Ta-Chia Town (TW)

Correspondence Address: BACON & THOMAS, PLLC, 625 SLATERS LANE, FOURTH FLOOR, ALEXANDRIA, VA, 22314

(73) Assignee: Zeroplus Technology Co., Ltd., Taipei Hsien (TW)

(21) Appl. No.: 10/237,793

(22) Filed: Sep. 10, 2002

(51) Int. Cl. A63F 13/00

(52) U.S. Cl. 463/36

(57) ABSTRACT

A photographic pointer positioning control device used with the main unit of a game system or the like to control the positioning of a pointer on the display screen of the game system by means of photographing the display screen with a video camera and then processing the video signal thus obtained through an image out-line and verification processing process and then computing the processed data through a computing unit into coordinate values corresponding to the aiming point of the video camera at the display screen to replace the function of a mouse, tablet, or light-gun in a computer system.

### BACKGROUND OF THE INVENTION

1. Field of the Invention

The present invention relates to a pointer positioning device adapted to control the positioning of a pointer on a display screen and, more particularly, to a photographic pointer positioning device that controls the positioning of a pointer on a display screen by means of photography. Instead of the functioning of a conventional light-gun of using bullet drop point signal or synchronous signal to obtain the coordinate value, the invention uses a video camera to photograph the display area of the display screen so as to obtain the actual coordinate values of the aiming point of the video camera at the display screen through the processing of an image processing circuit and the computing of a computing unit. The photographic pointer positioning device can be used in any of a variety of display screens to play a shooting game.

2. Description of the Related Art

For the advantages of fine picture quality of low manufacturing cost, picture tubes have been intensively used in TV and computer monitors since 1897. However, facing the challenge of a variety of TFT (thin-film transistor) LCDs, PDPs (plasma display panels), FPD (flat-panel displays), the leading role of picture tube displays becomes unstable. After 1990, TFT LCDs and PDPs have become more and more popularly accepted in the market. In addition to picture tube displays, there are known about ten kinds of display related techniques under developing. It is expected that TFT LCDs will take over the leading role of picture tube displays in the market in the near future. Nowadays, big size TFT LCDs have been intensively used in desktop computers instead of CDTs.

Further, since the commercialization of PDPs in 1985, big size products have been continuously disclosed. During “The 1998 Nagano Olympic Winter Game”, Japanese manufactures announced various newly developed PDPs.

Following PDPs, various projection systems are developed. For example, Barker Belgium disclosed a LCD projection system—“Reality 9200” that is capable of processing 200 million pixels per second to provide high resolution picture under bright illumination. Japan JVC also developed “Direct Drive Light Amplifier; D-DLA” by means of the application of LCD projection technology. “Direct Drive Light Amplifier; D-DLA” shows HDTV picture standards, or a high-resolution level next to S-XGA computer. US Texas Instrument disclosed a projection technology called DMD that provides clear and bright picture quality. These creations are still not satisfactory in function for the disadvantages of short service life of projection lights (about 250-500 hours) and high noise level of cooling fans. Further, there are well developed 3D projection systems using laser or hologram technology.

As indicated above, the development of display technology is fast. Similar to the development of TFT LCDs and PDPs, FEDs (Field emission displays) have been developed after CRT and CDT displays. Competition in the flat-panel display market is severe. Neither type of flat-panel displays shows a significant victory in the market.

In current shooting games, a light-gun may be used instead of a joystick to aim at the objective on the display screen, increasing the reality of the simulation of the game. In order to fit the design of game programs to be executed in the main unit of a game machine, second generation light-guns are developed within a short time after creation of first generation light-guns. A first generation light-gun lets the game program compute the coordinate values. A second generation light-gun computes the coordinate values of the aiming point at the display screen, and then feeds the coordinate values back to the main unit of the game machine. FIG. 1 illustrates a wired first generation light-gun 70 used with a game machine main unit 80. As illustrated, the signal cable of the light-gun 70 is directly connected to the connector of the game machine main unit 80. When the player aimed the light-gun 70 at the display screen 10 and fired a bullet drop point signal, the photo receiver 30 of the light-gun 70 receives a bullet drop point signal produced from the striking of CRT electrons against the aiming point of the light-gun 70 at the display screen 10 and then sends the signal back to the game machine main unit 80, thereby causing the game program running in the game machine main unit 80 to compute the coordinates of the aiming point of the light-gun 70 at the display screen 10 subject to the bullet drop point signal received from the photo-receiver 30 and the video signal 60 of the game machine main unit 80 for further game program processing.

According to conventional first generation light-guns and second generation light-guns, the bullet drop point signal processing or X, Y coordinate values computing of bullet drop point is executed subject to the bullet drop point signal or synchronous signal provided by the display screen. Further, conventional first generation light-guns and second generation light-guns cannot be used with a TFT LCD, PDP, projection system display screen, or any display means that cannot produce a bullet drop point signal or synchronous signal. Therefore, light-guns can only be used with a CDT or CRT display.

### SUMMARY OF THE INVENTION

The present invention has been accomplished under the circumstances in view. It is therefore the main object of the present invention to provide a photographic pointer positioning control device, which is suitable for use with any of a variety of display screens to control the positioning of the pointer. It is another object of the present invention to provide a photographic pointer positioning control device, which can be used in a computer system instead of a mouse, tablet, or light-gun. To achieve these and other objects of the present invention, the photographic pointer positioning control device comprises a video camera adapted to photograph the display area of the display screen, an image processing circuit adapted to process the video signal obtained from the video camera through an image out-line and verification processing process, and a computing unit adapted to compute the processed data into coordinate values corresponding to the aiming point of the video camera at the display screen, and a communication interface adapted to transmit the coordinate values to the game machine main unit for further processing.

### BRIEF DESCRIPTION OF THE DRAWINGS

FIG. 1 is a system block diagram showing the use of a wired light gun in a firing game according to the prior art.

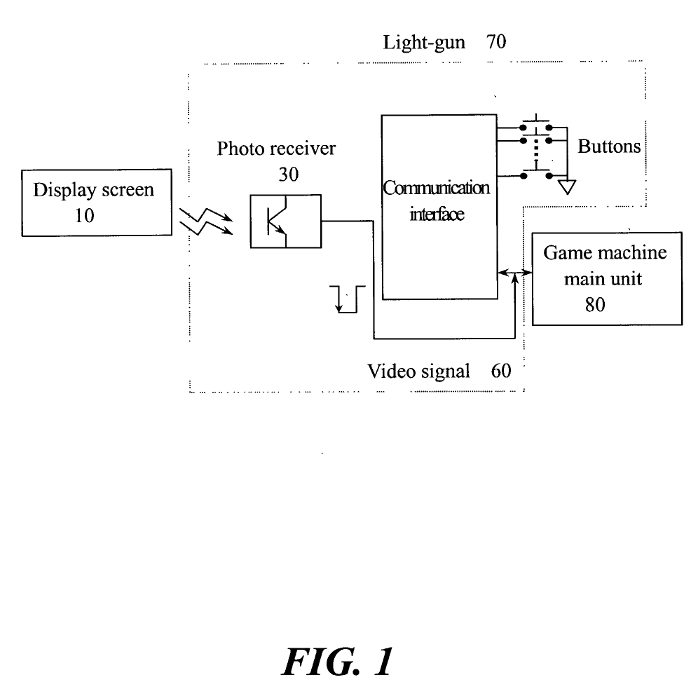

FIG. 2 is a block diagram of a photographic pointer positioning control device according to the first embodiment of the present invention.

FIG. 2A is a circuit diagram of the photographic pointer positioning control device according to the first embodiment of the present invention.

FIG. 3 is a flow chart explaining the operation steps of the first embodiment of the present invention.

FIG. 4 is a block diagram of a photographic pointer positioning control device according to the second present invention.

FIG. 5 is a flow chart explaining the operation steps of the second embodiment of the present invention.

### DETAILED DESCRIPTION OF THE PREFERRED EMBODIMENT

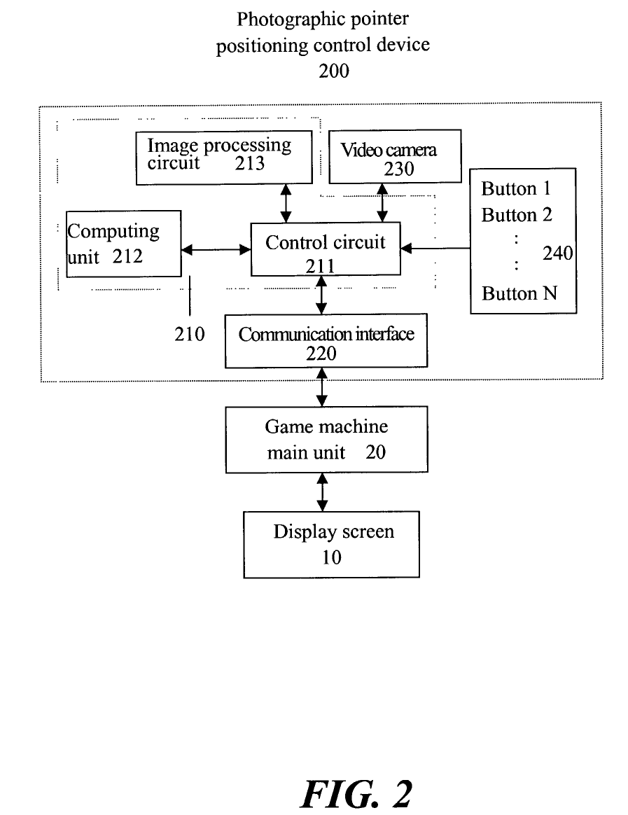

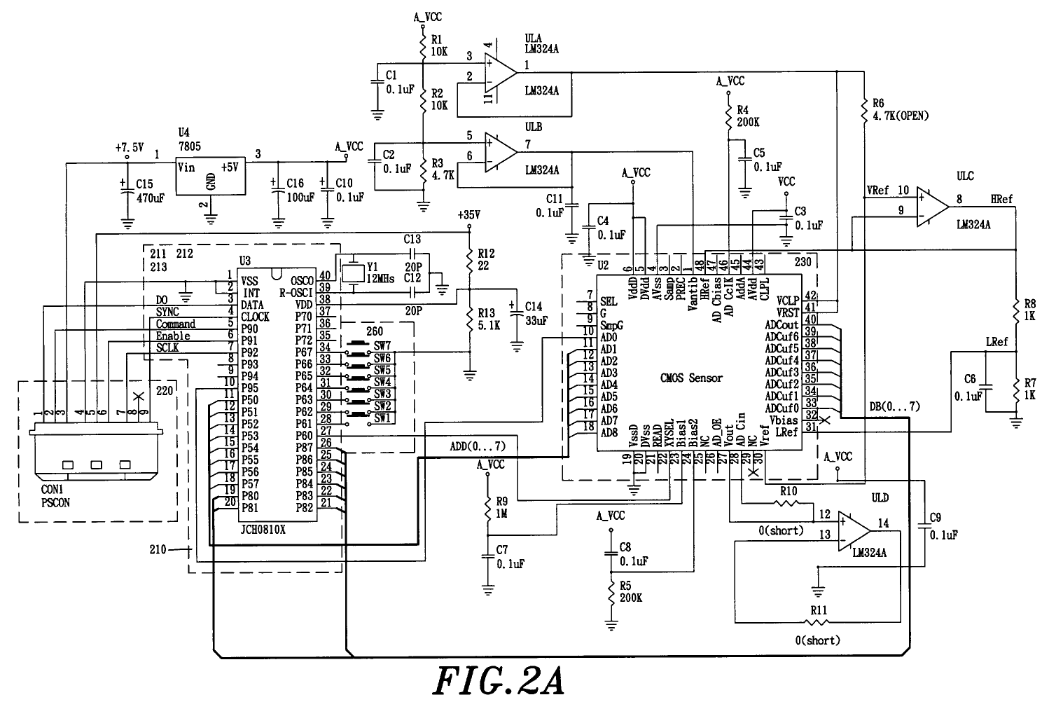

Referring to FIGS. 2 and 2A, a photographic pointer positioning control device 200 according to the first present invention has a communication interface 220 for connection to a game machine main unit 20, which has a display screen 10 connected thereto. The photographic pointer positioning control device 200 comprises a control unit 210, a video camera 230, and a set of buttons 240.

The control unit 210 comprises a control circuit 211, a computing unit 212, and an image processing circuit 213. The control circuit 211 is electrically connected to the buttons 240. The user can operate the buttons 240 to control the operation of the control circuit 211. The video camera 230, the computing unit 212, and the image processing circuit 213 are respectively electrically connected to the control circuit 211. The control circuit 211 controls the video camera 230 to photograph the whole display area of the display screen 10, and to transmit photographed video signal to the control circuit 211. Upon receipt of photographed video signal from the video camera 230, the control circuit 211 sends the signal to the image processing circuit 213 for image out-line and verification processing. The processed data thus obtained is then sent back to the control circuit 211 by the image processing circuit 213, so that the control circuit 211 inputs the processed video signal into the computing unit 212, enabling the computing unit 212 to compute the actual values of the coordinates of the aiming point of the video camera 230 at the display screen 10. The computing unit 212 outputs the computed coordinate values to the control circuit 211, enabling the computed coordinate values to be transmitted to the game machine main unit 20 by the control circuit 211 through the communication interface 220, so that the game machine main unit 20 can run the related program subject to the received coordinate values.

However, the control circuit 211, computing unit 212 and image processing circuit 213 of the control unit 210 of the aforesaid photographic pointer positioning control device 200 are integrated in a single chip JCH0810X. The video camera 230 is a CMOS sensor. The communication interface 220 corresponds to CONI PSCON. The buttons 240 correspond to switches SW1˜SW7.

Further, the control circuit 211 and computing unit 212 of the aforesaid control unit 210 can be integrated in a single chip and connected to the image processing circuit 213.

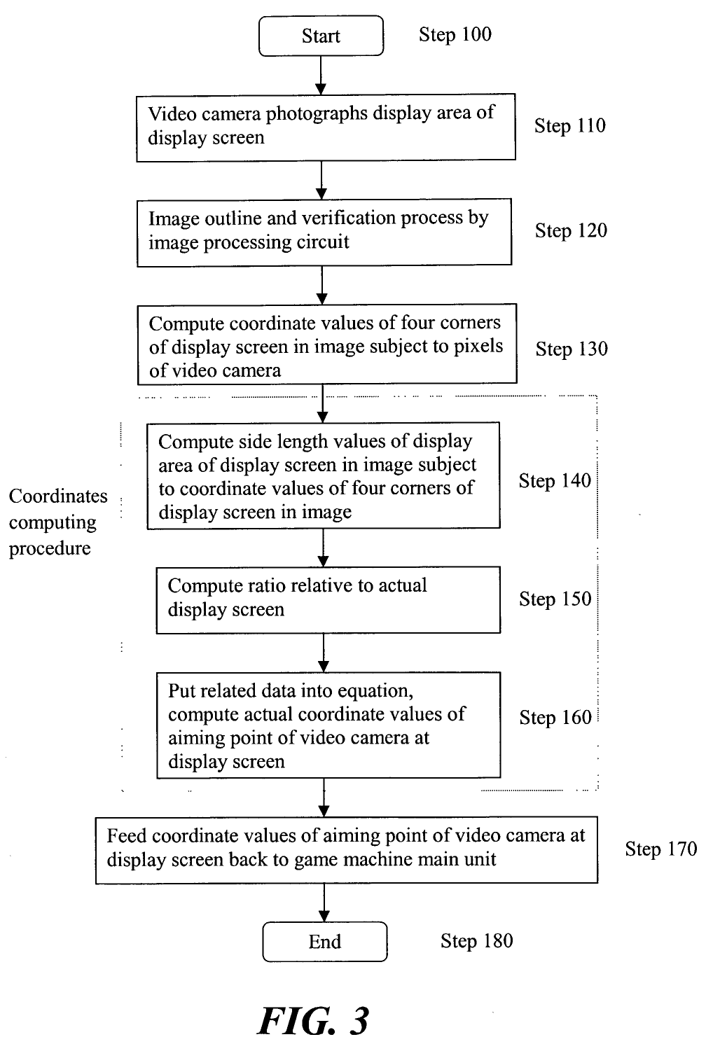

Referring to FIG. 3 and FIGS. 2 and 2A again, when the user using the game machine main unit 20, the photographic pointer positioning control device 200 and the display screen 10 to run a game program, the control circuit 211 proceeds subject to the following coordinate value computing and verification procedure, which include the steps of:

100 Start;

110 Control the video camera 230 to photograph the whole display area of the display screen 10, and then drive the video camera 230 to transmit photographed video signal to the control circuit 211;

120 Transmit the video signal received from the video camera 230 to the image processing circuit 213 for image out-line and verification processing, and then drive the image processing circuit 213 to transmit processed signal to the control circuit 211;

130 Identify data obtained from the image processing circuit 213 with the pixels of the video camera 230 so as to obtain the coordinate values of the four corners of the display area of the display screen 10 in the photographed image;

140 Send the coordinate values of the four corners of the display area of the display screen 10 in the photographed image and the coordinate values of the center point of the video camera 230 to the computing unit 212, and then drive the computing unit 212 to put these coordinate values into a distance formula, so as to obtain the side lengths of the sides of the display area of the display screen 10 in the image;

150 Drive the computing unit 212 to compute the ratio between the computed side lengths and the actual side lengths of the display screen 10, and then multiply the side lengths of the display area of the display screen 10 in the image by the ratio so as to obtain the values of the side lengths at the display screen 10, and then drive the computing unit 212 to send the actual side lengths data to the control circuit 211;

160 Use the actual side lengths thus obtained from the computing unit 212 to write an affected quadratic simultaneous equation with two unknown, and then send the related data to the computing unit 212, for enabling the computing unit 212 to find the solution of the affected quadratic simultaneous equation with two unknown by means of the data obtained and to feed the X, Y values thus obtained to the control circuit 211;

170 Receive the X, Y values from the computing unit 212, and judge the X, Y values to be the coordinate values of the aiming point of the video camera 230, and then send the data through the communication interface 220 to the game machine main unit 20, for enabling the game machine main unit 20 to run the program subject to the coordinate values of the aiming point of the video camera 230;

180 End.

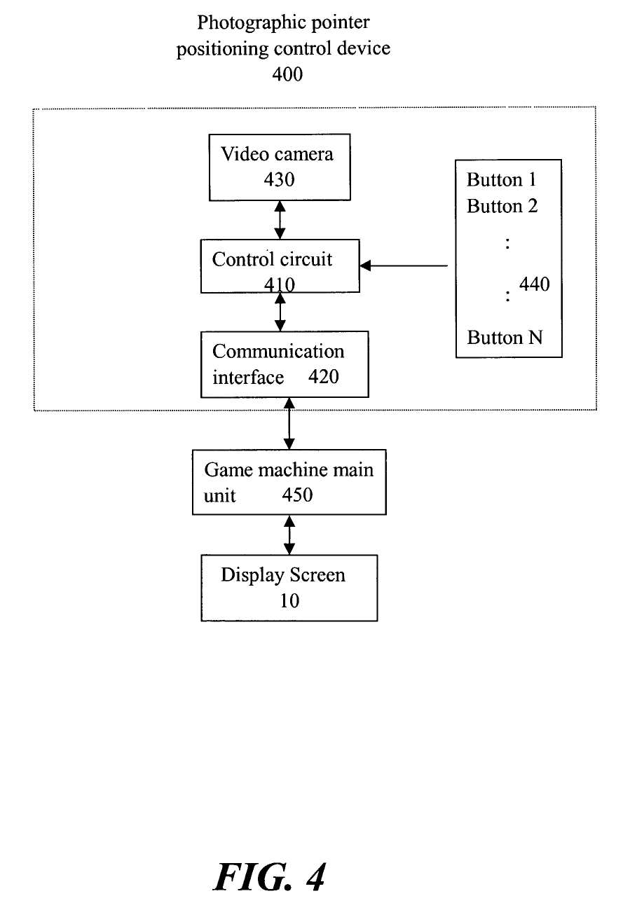

FIG. 4 shows a photographic pointer positioning control device 400 according to the second embodiment of the present invention. This second embodiment is similar to the aforesaid first embodiment with the exception of the processing of the video signal from the video camera. According to the first embodiment of the present invention as shown in FIG. 2, the coordinate values of the actual display area of the display screen 10 and the coordinate values of the aiming point of the video camera 230 are directly computed in the photographic pointer positioning control device 200 and then sent to the game machine main unit 20. According to the second embodiment of the present invention, video signal is directly sent to the game machine main unit 450 before processing, and the game machine main unit 450 processes the video signal to obtain the coordinate values of the actual display area of the display screen 10 and the coordinate values of the aiming point of the video camera 230.

Referring to FIG. 4 again, the photographic pointer positioning control device 400 comprises a communication interface 420 connected to the game machine main unit 450, a control circuit 410, a video camera 430, and a set of buttons 440. The control circuit 410 is respectively electrically connected to the video camera 430 and the buttons 440. The user can operate the buttons 440 to control the operation of the control circuit 410.

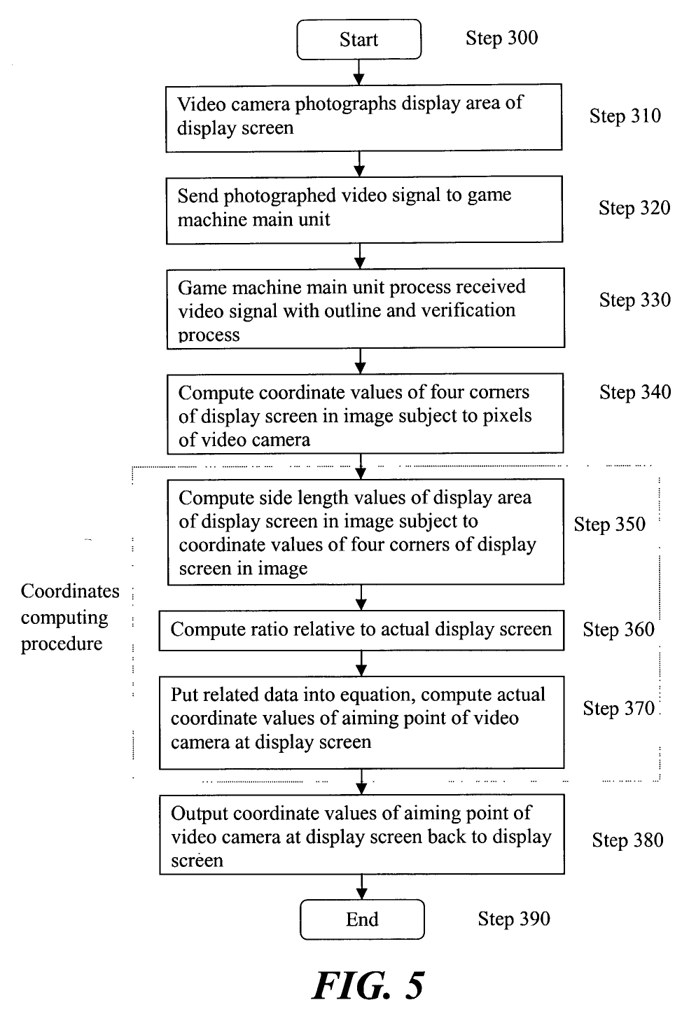

Referring to FIG. 5 and FIG. 4 again, when the user using the game machine main unit 450, the photographic pointer positioning control device 400 and the display screen 10 to run a game program, the control circuit 410 proceeds subject to the following coordinate value computing and verification procedure, which include the steps of:

300 Start;

310 The control circuit 410 controls the video camera 430 to photograph the whole display area of the display screen 10 and then to transfer photographed video signal to the control circuit 410;

320 The control circuit 410 transfers the received video signal to the game machine main unit 450 through the communication interface 420;

330 The game machine main unit 450 processes the video signal received from the control circuit 410 through an image out-line and verification processing procedure;

340 The game machine main unit 450 identifies the processed data with the pixels of the video camera 430 so as to obtain the coordinate values of the four corners of the display area of the display screen 10 in the photographed image;

350 The game machine main unit 450 puts the coordinate values of the four corners of the display area of the display screen 10 in the photographed image and the coordinate values of the center point of the video camera 430 into a distance formula, so as to obtain the side lengths of the sides of the display area of the display screen 10 in the photographed image;

360 The game machine main unit 450 computes the ratio between the computed side lengths and the actual side lengths of the display screen 10, and then multiplies the side lengths of the display area of the display screen 10 in the photographed image by the ratio so as to obtain the values of the actual side lengths at the display screen 10;

370 The game machine main unit 450 uses the actual side lengths thus obtained to write an affected quadratic simultaneous equation with two unknown, and then finds the solution of the affected quadratic simultaneous equation with two unknown by means of the data obtained, and the solution thus obtained is the X, Y values of the aiming point of the photographic pointer positioning control device 400;

380 Output the coordinate values of the aiming point of the video camera 430 to the display screen 10, and run the game program;

390 End.

Referring to FIGS. 2 and 4 again, the photographic pointer positioning control device can also be used in a computer system, big scale game machine, video game machine, or computer terminal system. When used in a computer system, the photographic pointer positioning control device replace the function of a mouse, tablet, or light-gun.

The communication interface 220 or 420 of the photographic pointer positioning control device 200 or 400 can be a USB (universal serial bus) interface, 1394 interface, PS2 interface, or any of a variety of suitable connection interfaces connectable to the game machine main unit 20 or 450 through a signal line for enabling the control circuit 211 or 410 to transmit signal through a wired communication method.

According to the present invention, the communication interface 220 or 420 is a wireless transmitting receiving interface having radio transmitter receiver circuit means. The game machine main unit 20 or 450 has a corresponding radio transmitter receiver circuit means for signal transmission with the control circuit 211 or 410 wirelessly.

A prototype of photographic pointer positioning control device has been constructed with the features of the annexed drawings of FIGS. 2˜5. The photographic pointer positioning control device functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A photographic pointer positioning control device used with the main unit of an electronic system to control the positioning of a pointer on a display screen being connected to said main unit of said electronic system, comprising:
a video camera adapted to photograph the display area of said display screen;
a control unit electrically connected to said video camera and adapted to receive photographed image from said video camera and to produce a coordinate data of the aiming point of said video camera on said display screen;
a communication interface electrically connected to said control unit and adapted to transmit said coordinate data from said control unit to said main unit of said electronic system; and
a set of buttons respectively electrically connected to said control unit for signal input by the user to control the operation of said control unit;
wherein said control unit comprises:
a control circuit adapted to control said video camera to photograph the display area of said display screen and to transmit photographed video signal from said video camera to an image processing circuit;
an image processing circuit electrically connected to said control circuit and adapted to process the photographed video signal received from said control circuit through an image out-line and verification processing and to feed the processed data back to said control circuit; and
a computing unit electrically connected to said control unit and adapted to compute the actual values of the coordinates of the aiming point of said video camera at said display screen subject to the processed data obtained from said image processing circuit through said control circuit, and to send the computed coordinate values back to said control circuit.

2. The photographic pointer positioning control device as claimed in claim 1, wherein said control circuit, said image processing circuit and said computing circuit of said control unit are integrated into a single chip.

3. The photographic pointer positioning control device as claimed in claim 1, wherein said control circuit and said computing circuit of said control unit are integrated into a single chip, which is electrically connected to said image processing circuit.

4. The photographic pointer positioning control device as claimed in claim 1, wherein said electronic system is a computer system.

5. The photographic pointer positioning control device as claimed in claim 4, wherein the photographic pointer positioning control device replaces the functions of a mouse, a tablet, and a light-gun.

6. The photographic pointer positioning control device as claimed in claim 1, wherein said electronic system is a game system.

7. The photographic pointer positioning control device as claimed in claim 1, wherein said electronic system is a computer terminal system.

8. A photographic pointer positioning control device used with the main unit of an electronic system to control the positioning of a pointer on a display screen being connected to said main unit of said electronic system, comprising:
a control circuit;
a video camera controlled by said control circuit to photograph the display area of said display screen and to send the photographed video signal to said control circuit for enabling said control circuit to produce a coordinate data of the aiming point of said video camera at said display screen subject to said photographed video signal;
an image processing circuit controlled by said control circuit to process said photographed video signal through an image out-line and verification processing and to feed the processed data back to said control circuit;
a computing unit controlled by said control circuit to compute the actual values of the coordinates of the aiming point of said video camera at said display screen subject to the processed data obtained from said image processing circuit through said control circuit, and to send the computed coordinate values back to said control circuit;
a communication interface controlled by said control circuit to transmit said coordinate data from said control circuit to said main unit of said electronic system; and
a set of buttons for signal input by the user to control the operation of said control unit.

9. The photographic pointer positioning control device as claimed in claim 8, wherein said electronic system is a computer system.

10. The photographic pointer positioning control device as claimed in claim 9, wherein the photographic pointer positioning control device replaces the functions of a mouse, a tablet, and a light-gun.

11. The photographic pointer positioning control device as claimed in claim 8, wherein said electronic system is a game system.

12. The photographic pointer positioning control device as claimed in claim 8, wherein said electronic system is a computer terminal system.

13. A photographic pointer positioning control device used with the main unit of an electronic system to control the positioning of a pointer on a display screen being connected to said main unit of said electronic system, comprising:
a control circuit;
a video camera controlled by said control circuit to photograph the display area of said display screen and to send the photographed video signal to said control circuit;
a communication interface electrically connected to said control circuit and connected to said main unit of said electronic device through serial connection means and adapted to transmit said photographed video signal from said control circuit to said main unit of said electronic system for enabling said main unit of said electronic system to produce a coordinate data of the aiming point of said video camera at said display screen subject to said photographed video signal and to output the coordinate data to said display screen for controlling the positioning of said pointer on said display screen; and
a set of buttons for signal input by the user to control the operation of said control unit.

14. The photographic pointer positioning control device as claimed in claim 13, wherein said electronic system is a computer system.

15. The photographic pointer positioning control device as claimed in claim 14, wherein the photographic pointer positioning control device replaces the functions of a mouse, a tablet, and a light-gun.

16. The photographic pointer positioning control device as claimed in claim 13, wherein said electronic system is a game system.

17. The photographic pointer positioning control device as claimed in claim 13, wherein said electronic system is a computer terminal system.
